(19) United States
(12) Patent Application Publication
(10) Pub. No.: US 2011/0139636 A1
(43) Pub. Date: Jun. 16, 2011

(54) GOLD-PLATED SCREEN-PRINTED ELECTRODES AND THEIR USE AS ELECTROCHEMICAL SENSORS

(76) Inventors: Rebecca Y. Lai, Lincoln, NE (US); Weiwei Yang, Lincoln, NE (US)

(21) Appl. No.: 12/967,547

(22) Filed: Dec. 14, 2010

Related U.S. Application Data
(60) Provisional application No. 61/286,233, filed on Dec. 14, 2009.

(51) Int. Cl. G01N 27/327; C25B 11/04; B41M 1/12

(52) U.S. Cl. 205/792; 204/290.08; 204/403.01; 205/183; 101/129

(57) ABSTRACT

This disclosure describes a gold-plated screen-printed electrode for use as an electrochemical sensor.

### CROSS-REFERENCE TO RELATED APPLICATIONS

This application claims benefit of priority from U.S. Provisional Application Ser. No. 61/286,233, filed on Dec. 14, 2009, of which is incorporated herein by reference in its entirety.

### TECHNICAL FIELD

This disclosure generally relates to electrochemical sensors.

### BACKGROUND

The use of electrochemical sensors in the medical field for testing various blood or urine analytes and in the environmental field for monitoring water or soil contamination is well known. In the presence of a target analyte in a sample, a difference in potential is generated across two or more of the electrodes of the electrochemical sensor. Recently, an electrochemical sensor that is dependent upon conformational changes in a biopolymer has been developed that is fully electronic and requires neither optics nor high voltage power supplies. This disclosure describes the fabrication of such electrochemical sensors that is amenable to mass production and commercialization.

### SUMMARY

This disclosure describes a gold-plated screen-printed electrode for use as an electrochemical sensor.

In on aspect, an electrode is provided that includes a screen-printed working electrode; a screen-printed reference electrode; a screen-printed counter electrode; and gold deposited on the working electrode. In one embodiment, the substrate is paper. Such an electrode also can include at least one binding ligand covalently attached to the gold. Representative binding ligands include nucleic acids, aptamers, polypeptides, and proteins.

In another aspect, an electrochemical biosensor is provided. Such an electrochemical biosensor typically includes a paper-substrate electrode comprising a working electrode, a reference electrode, and a counter electrode; a gold pixel in contact with the working electrode; and at least one binding ligand covalently attached to the gold pixel. Representative binding ligands include nucleic acids, aptamers, polypeptides, and proteins.

In still another aspect, methods of making electrochemical biosensors are provided. Such methods typically include screen-printing a working electrode onto a substrate using conductive carbon inks; screen-printing a reference electrode onto the substrate using silver/silver chloride inks; screen-printing a counter electrode onto the substrate using conductive carbon inks; depositing gold on the working electrode; and covalently attaching a binding ligand to the substrate, wherein the binding ligand comprises an electron transfer moiety. In one embodiment, the substrate is paper. In one embodiment, the electrochemical biosensor is disposable. In certain instances, the gold (e.g., gold/gold chloride or another gold salt) is deposited by electroplating. In certain instances, the depositing time for the gold is between about ten minutes to about forty minutes (e.g., about ten minutes, about twenty minutes, about thirty minutes).

The methods described herein further can include smoothing the gold prior to covalently attaching the binding ligand. In one embodiment, the roughness factor (fᵣ) of the gold pixel is less than about 7.

In yet another aspect, methods of detecting the presence of absence of a target analyte in a sample is provided. Such methods generally include contacting the electrode or the biosensor described herein with a sample; determining whether or not a change in redox potential occurs; wherein a change in the redox potential is indicative of the presence of the target analyte and wherein no change in the redox potential is indicative of the absence of the target analyte.

Unless otherwise defined, all technical and scientific terms used herein have the same meaning as commonly understood by one of ordinary skill in the art to which the methods and compositions of matter belong. Although methods and materials similar or equivalent to those described herein can be used in the practice or testing of the methods and compositions of matter, suitable methods and materials are described below. In addition, the materials, methods, and examples are illustrative only and not intended to be limiting. All publications, patent applications, patents, and other references mentioned herein are incorporated by reference in their entirety.

DESCRIPTION OF DRAWINGS

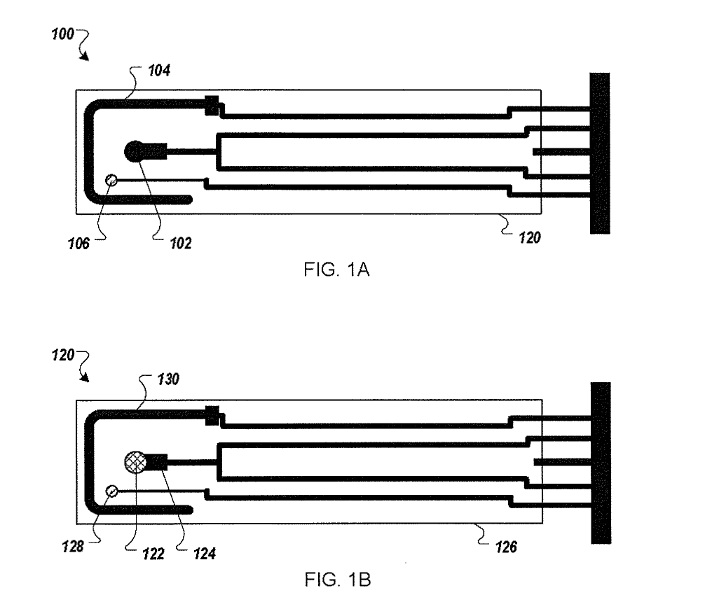

FIG. 1A illustrates example screen-printed electrodes. FIG. 1B illustrates example screen-printed electrodes that include a gold pixel in contact with a working electrode.

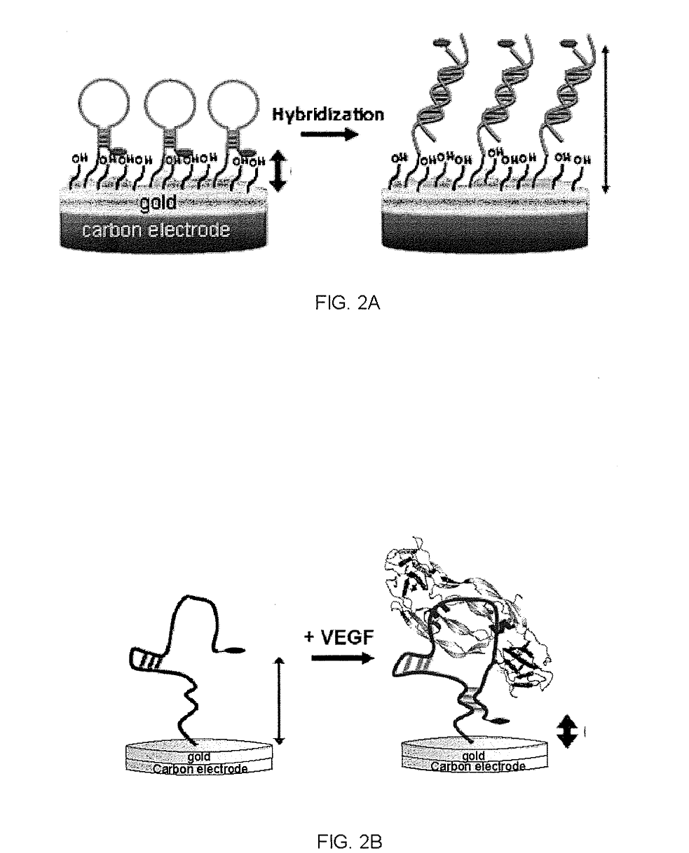

FIG. 2A illustrates an example gold-plated screen-printed carbon electrode based electrochemical E-DNA sensor construct and signaling mechanism for a signal-off E-DNA sensor. FIG. 2B illustrates an example gold-plated screen-printed carbon electrode based electrochemical aptamer-based sensor construct and signaling mechanism for a signal-on vascular endothelial growth factor sensor.

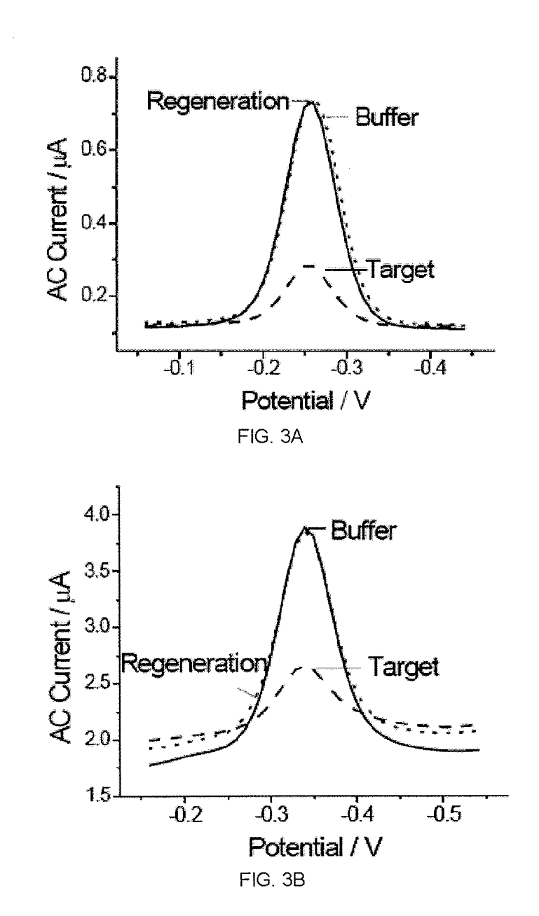

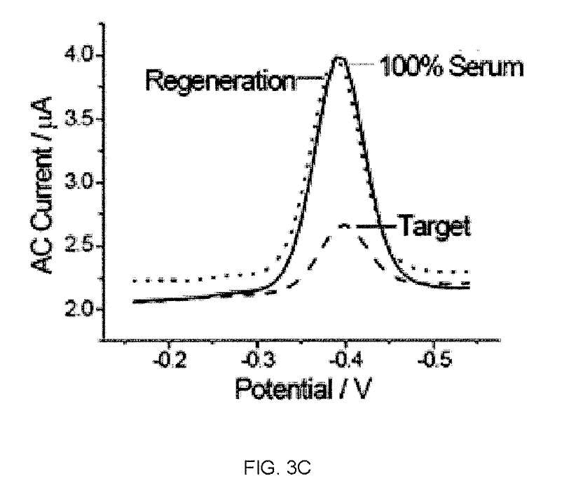

FIGS. 3A, 3B and 3C are AC voltammograms of E-DNA sensors fabricated on gold disk electrode (A) and 20 min-GPE (B, C) before hybridization, after incubation with 1.0 uM of target WT-Gly DNA, and after regeneration via a simple, room temperature rinse with deionized water. The sensors perform well in either buffer (A, B) or 100% blood serum (C). Conditions: AC frequency: 10 Hz; AC amplitude: 25 mV; incubation time: 80 min in physiological buffer solution (Phys, pH 7.0), 100 min in fetal calf serum.

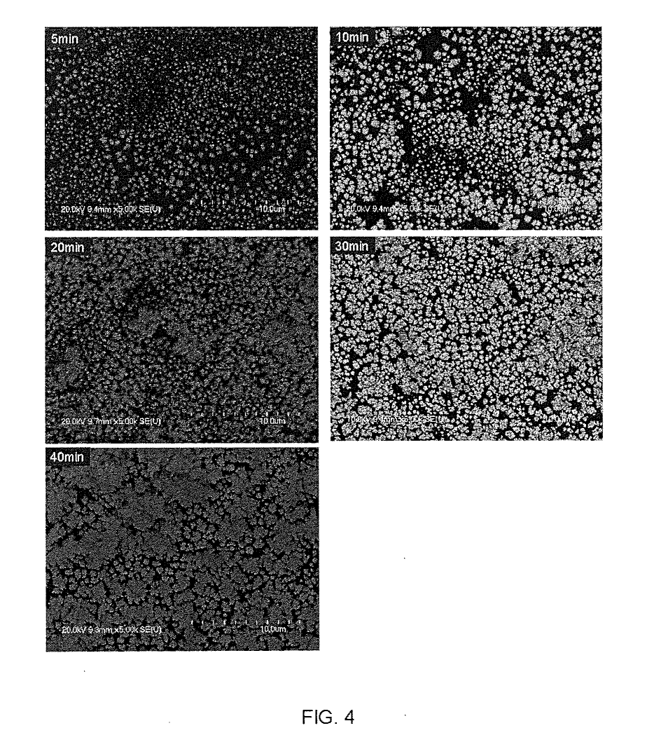

FIG. 4 are SEM images of GPEs with varied deposition time. Conditions: direct current voltage of −0.40 V (vs. Ag/AgCl) in stirred gold solutions (1.2 mg mL-1 HAuCl₄, 1.5 wt. % HCl and 0.1 M NaCl); Top: left to right: 5 min, 10 min; Center: left to right: 20 min, 30 min; Bottom: 40 min.

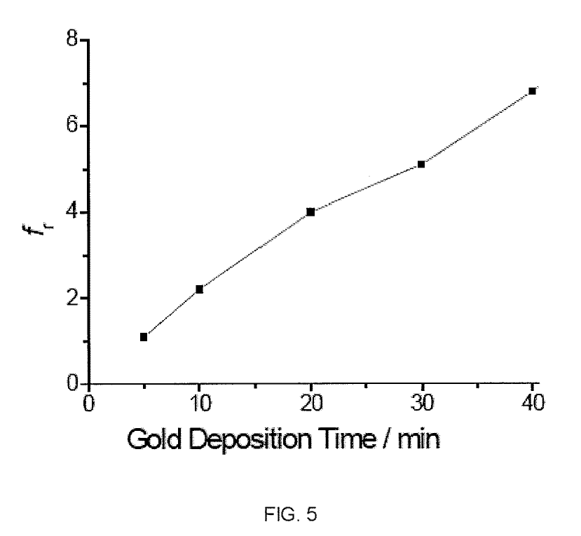

FIG. 5 is a graph showing the influence of gold deposition time on the roughness factor (fᵣ) of the GPE surface.

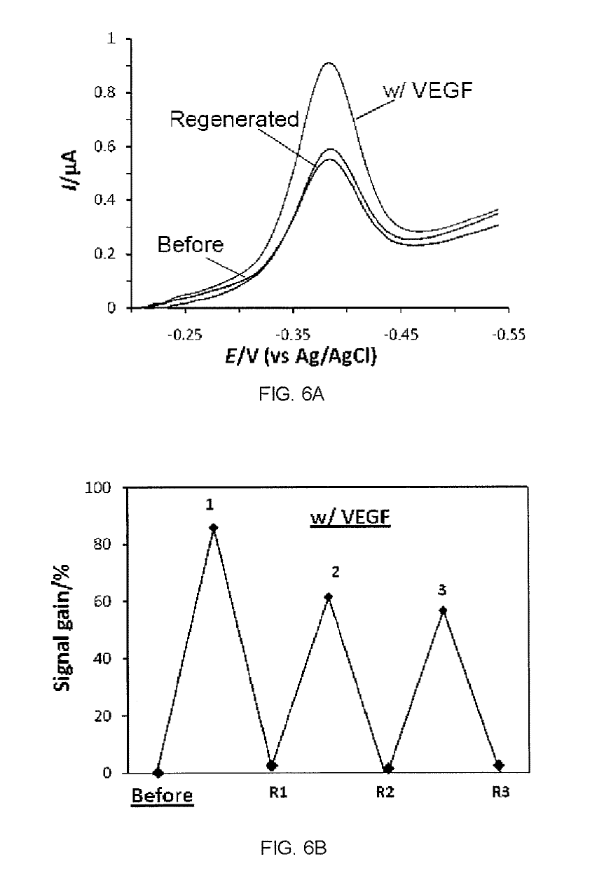

FIG. 6A is a graph showing the sensor response of the VEGF E-AB. FIG. 6B is a graph showing the reusability of the VEGF E-AB sensor.

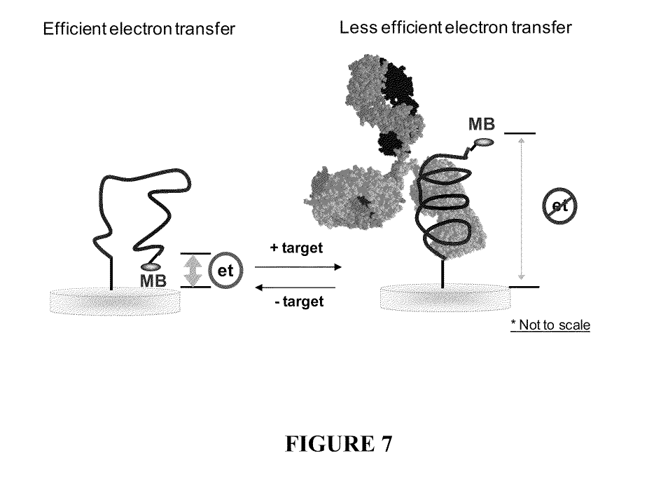

FIG. 7 is a schematic of an E-PB sensor construct and signaling mechanism. In the absence of target, the peptide probe is unstructured and highly flexible, facilitating efficient electron transfer to and from the redox label via collisional electron transfer. Binding of the target induces a significant change in the dynamics of the peptide probe, therefore producing a readily detectable reduction in the current.

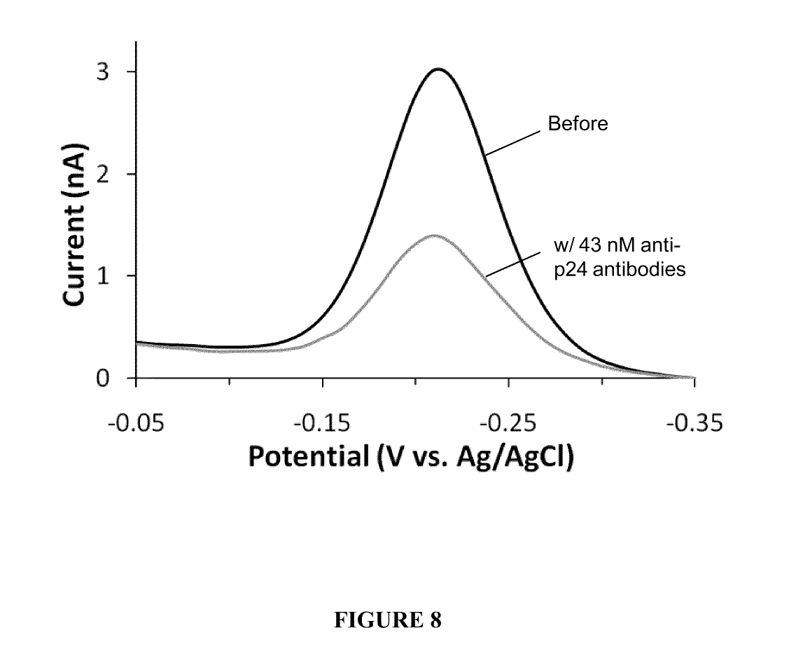

FIG. 8 is a graph of the sensor interrogation in AC voltammetry with 43 nM anti-p24 antibodies in a 1:1 human urine proxy:physiological buffer. The AC voltammograms shown are averages of three different sensors with similar probe density.

Like reference symbols in the various drawings indicate like elements.

### DETAILED DESCRIPTION

Electrochemical biosensors are used to detect a target analyte in a sample. See, for example, U.S. Pat. Nos. 5,418,142; 5,951,836; 6,432,723 and US 2007/0020641. This disclosure describes a gold-plated screen-printed electrode (GPE) and methods of making such an electrode. The GPEs described herein cost significantly less than conventional glass electrodes and can be readily mass produced. Therefore, the GPEs described herein, though reusable, can be disposable. The electrochemical sensors using the GPEs described herein can be used, for example, in point-of-care diagnostics or for on-site detection of one or more analytes.

FIG. 1A illustrates an example of a screen-printed electrode 100. Screen-printed electrodes are well known in the art. See, for example, U.S. Pat. Nos. 4,185,131;

5,682,884; 5,727,548; and 5,820,551. Typically, a screen-printed electrode includes a working electrode (WE) 102, a counter electrode (CE) 104 and a reference electrode (RE) 106, although a 2-component electrode, in which the reference electrode additionally acts as the counter electrode, also can be used. The electrodes are screen-printed onto a substrate using conductive inks The substrate of a screen-printed electrode can be paper, plastic, or ceramic. Conductive inks can include silver, gold, carbon, dielectric polymer, or nickel. It is understood by those in the art that different conductive inks have varying stabilities in the presence of, for example, different ions. Accordingly, the particular conductive ink(s) used on a screen-printed electrode can be selected based on the particular application (e.g., the sample to which the electrochemical biosensor will be exposed). In one embodiment, the WE and the CE are screen-printed with conductive carbon inks and the RE is screen-printed with conductive silver chloride inks

This disclosure describes screen-printed electrodes onto which a gold pixel has been applied, referred to herein as “a gold-plated screen-printed electrode” or GPE. FIG. 1B illustrates an example of a screen-printed electrode 120 as described in FIG. 1A that further includes a gold pixel 122 in contact with the working electrode (WE) 124. The gold can be applied to the screen-printed electrode using electrodeposition or electroplating. Electrodeposition or electroplating is a process for producing a metallic coating on a surface using the action of an electric current. For example, a gold film can be electrodeposited onto the WE 124 by placing a negative potential on the WE 124 while the screen-printed electrode strip 120 is immersed in a solution (an electrolyte or plating bath) that contains the desired metal to be deposited (e.g., gold). The metal to be deposited is generally in the form of a salt (e.g., gold chloride (HAuCl₄), gold cyanide (Au(CN)₂), or gold sulfates (Au(SO₄)₂)). The positively charged gold ions (Au³) are attracted to the negatively charged WE 124, where they are reduced to their metallic form (Au⁰), thereby coating the WE 124 with a gold film and forming the gold pixel 122. In other implementations, platinum, silver, nickel, palladium, gold, silver, copper, iridium, rhodium, or mercury can be electrodeposited or electroplated onto a WE 124.

A GPE as described herein can be used as an electrochemical sensor by covalently attaching a binding ligand to the gold pixel. As used herein, a binding ligand is a compound that is used as a probe for the presence of the target analyte and that undergoes a conformational change upon binding by the target analyte. As will be appreciated by those in the art, the particular binding ligand used will depend on the target analyte being detected. Binding ligands for a wide variety of analytes are known or can be readily identified using known techniques. For example, when the target analyte is a protein, the binding ligand can be an antibody or a fragment thereof (e.g., FAbs) or a nucleic acid that undergoes a conformational change upon binding by the target analyte; when the analyte is a metal ion, the binding ligand can be a traditional metal ion ligand or a chelator that undergoes a conformational change as a result of binding by the metal ion. Aptamers also are useful as binding ligands. Additional binding ligands suitable for use with the GPEs described herein can be found, for example, in U.S. Pat. No. 6,432,723 and US 2007/0020641. Virtually any compound can be used as a binding ligand provided that it undergoes a conformational or positional change upon binding by the target analyte. Methods of attaching a binding ligand to a GPE as described herein are well-known in the art and include, without limitation, covalent linkers or, when the pixel is gold, sulfur groups (e.g., thiols).

To complete the electrochemical sensor, the binding ligand includes a redox tag. Redox tags are well known in the art and include, without limitation, purely organic redox labels, such as viologen, anthraquinone, ethidium bromide, daunomycin, methylene blue, and their derivatives, organo-metallic redox labels, such as ferrocene, ruthenium, bis-pyridine, tris-pyridine, osmium tris-bipyridine, cobalt tris-bipyridine, bis-imidizole, and their derivatives, and labels such as oxazine and derivatives thereof (e.g., ifosfamide and tetrahydro-1,4-oxazine).

FIG. 2A illustrates an example of a electrochemical sensor that includes a nucleic acid binding ligand (E-DNA). Such a binding ligand can be used, for example, for the sequence-specific detection of a polymorphism. FIG. 2A shows an embodiment in which the E-DNA sensor includes a redox-tagged stem-loop DNA probe covalently attached to the gold pixel on the electrode. A signal can occur due to the binding-induced change in the conformation of the stem-loop probe and the efficiency with which the attached redox tag transfers electrons to the electrode. In the absence of any target analyte, the stem-loop structure can hold the redox tag in proximity to the electrode, enabling efficient electron transfer between the redox tag and the electrode and resulting in the generation of a measurable redox current. Upon binding by the target analyte (e.g., complementary target DNA), the double-stranded conformation of the probe DNA disrupts the stem-loop structure and forces the redox tag away from the electrode, impeding the electron transfer between the redox tag and the electrode and resulting in a detectable reduction in the measurable redox current. This type of E-DNA sensor can be referred to as a signal-off sensor. In some implementations, a signal-on E-DNA sensor can be designed such that binding by the target analyte produces a conformational change that enhances the efficiency of the electron transfer between the redox tag of the stem-loop DNA probe and the electrode, leading to an increase in the measureable redox current.

Nucleic acids are well known in the art and include DNA molecules and RNA molecules as well as DNA or RNA molecules containing one or more nucleotide analogs. Nucleic acids used in electrochemical sensors can be single-stranded or double-stranded, which is generally dictated by its intended use. Nucleic acids used in electrochemical sensors as described herein typically are at least 10 nucleotides in length (e.g., at least 20, 25, 30, 40, 50, 75, 80, or 95 nucleotides in length) and can be as many as one or several hundred bases in length (e.g., 100 bp, 350 bp, 500 bp, 800 bp, or 950 bp) or several thousand bases in length (e.g., 1000 bp, 2 kb, 3.5 kb, 4.2 kb, 5.0 kb, or more). In certain embodiments, nucleic acids used in electrochemical sensors can be about 15 bp-about 5 kb, about 15 bp-about 2.5 kb, about 15 bp-about 1000 bp, about 20 bp-about 1000 bp, about 20 bp-about 500 bp, about 25 bp-about 5 kp, about 25 bp-about 1 kb, or about 50 bp-about 1 kb in length. Methods of making or obtaining nucleic acids are routine to those skilled in the art. Representative methods of making or obtaining (e.g., isolating) nucleic acids include, for example, chemical synthesis, cloning, or PCR amplification.

FIG. 2B illustrates an example of an electrochemical sensor in which the binding ligand for detecting a target analyte is an aptamer. An aptamer-based electrochemical sensor (E-AB) can include a redox tagged aptamer covalently attached to an electrode. In the absence of the target analyte (e.g., a protein), the conformation of the aptamer is such that the redox tag is positioned away from the electrode, impeding or disabling the electron transfer between the redox tag and the electrode and resulting in the generation of little or no measurable redox current. In the presence of the target analyte, the conformation of the aptamer forces the redox tag towards the electrode, enabling efficient electron transfer between the redox tag and the electrode and resulting in the generation of a measurable redox current. An electrical signal can occur due to the binding-induced change in the conformation of the binding ligand and the efficiency with which the attached redox tag transfers electrons to the electrode. As indicated above, this type of sensor can be referred to as signal-on sensor but, alternately, can be configured to be a signal-off sensor.

Aptamers also are well known in the art and can include both nucleic acids (e.g., oligonucleotides) and polypeptides. Aptamers refer to nucleic acids or polypeptides that bind to a specific target molecule, and typically are obtained by selection from a large random-sequence pool. However, natural aptamers also exist. Nucleic acid aptamers or polypeptide aptamers can be used in electrochemical sensors as described herein.

Although not specifically shown in a figure, this disclosure includes electrochemical sensors in which the binding ligand for detecting a target analyte is a polypeptide or a protein. A polypeptide- or protein-based electrochemical sensor (E-PB) can include a redox-tagged polypeptide or protein covalently attached to an electrode. In some embodiments, a polypeptide may be bound to an electrode to be used as an electrochemical sensor so as to detect a target protein, e.g., an antibody. In other embodiments, an antibody may be bound to an electrode to be used as an electrochemical sensor so as to detect a target polypeptide or protein.

Polypeptides are well known in the art and refer to multiple amino acids or amino acid analogues joined by peptide bonds. Polypeptides used in electrochemical sensors as described herein can be at least about 10 amino acids (aa) in length (e.g., at least about 12 aa, 15 aa, 20 aa, 25 aa, 30 aa, 40 aa, 50 aa, 60 aa, 70 aa, 80 aa, 90 aa, or 95 aa in length), at least about 100 aa in length (e.g., at least about 125 aa, 200 aa, 250 aa, 375 aa, 500 aa, 650 aa, 725 aa, 875 aa, or 900 aa in length), or at least about 1000 aa in length (e.g., at least about 1250 aa, 1500 aa, 1750 aa, 2000 aa, 2500 aa, 3000 aa, or more in length). For example, polypeptides can be about 10 aa-about 500 aa, about 20 aa-about 100 aa, or about 25 aa-about 50 aa in length. Polypeptides also can be a full-length protein expressed from a nucleic acid sequence (e.g., a gene). Polypeptides can be obtained (e.g., purified) from natural sources (e.g., a biological sample) by known methods such as DEAE ion exchange, gel filtration, and hydroxyapatite chromatography. Polypeptides also can be obtained by expressing a nucleic acid (e.g., from an expression vector). In addition, polypeptides can be obtained by chemical synthesis. The amount and/or purity of a polypeptide can be measured using any appropriate method, e.g., column chromatography, polyacrylamide gel electrophoresis, or HPLC analysis.

The electrochemical sensors described herein can be used to determine whether or not a target analyte is present in a sample. Samples can be biological samples (e.g., whole blood, blood serum, plasma, saliva, urine, cell lysates, tissue digests, or cell media), environmental samples (e.g., sea water, ground water, or soil samples), and food samples (e.g., milk, tissue samples, meat extracts, beer and other beverages). The electrochemical sensors described herein can be contacted with any such sample and the redox potential measured to determine whether or not the target analyte is present.

In some implementations, screen-printed electrochemical biosensors can be configured as voltammetric electrochemical biosensors that utilize alternating current voltammetry in a solution or buffer that includes a sample. The use of voltammetry allows control of the potential (voltage) of an electrode in contact with an analyte while the resulting current is measured. For example, a voltammetric scan can obtain information about a target analyte from an electrochemical biosensor by measuring current at a first electrode (e.g., a working electrode), where the current results from the transfer of electrons between the electrode and the analyte. A second electrode (e.g., a reference electrode) generally is a half cell with a known reduction potential (voltage), which does not pass any current between it and the analyte and acts as a reference in measuring and controlling the potential at the first electrode. A third electrode (e.g., a counter electrode) can pass the current needed to balance the current observed at the first electrode (e.g., the counter electrode).

Alternating current voltammetry (ACV), for example, can include superimposing a small alternating voltage of a constant magnitude on a voltammetric scan. A plot of alternating current verses the voltage applied to a working electrode provides a qualitative measure of the electrode process. In some implementations, low frequency (e.g., 10 Hz.) small alternating voltages (e.g., 25 millivolts (mV)) can provide maximum peak resolution. Other forms of voltammetry can also be used that can include, but are not limited to, cyclic voltammetry, linear sweep voltammetry, normal pulse voltammetry, differential pulse voltammetry, and square wave voltammetry.

The GPEs described herein can include one or more binding ligands that recognize a single target analyte or, in alternative embodiments, a GPE as described herein can include at least two different binding ligands that recognize at least two different target analytes. Microarray technology is well known in the art, and can be similarly applied to the placement of binding ligands on a GPE described herein.

In addition and as discussed below in the Examples, the deposition time can affect the performance of an electrochemical biosensor. As described herein, a deposition time of about ten minutes to about 40 minutes was effective for reproducible and sensitive detection. For the particular binding ligands exemplified herein, it was determined that 10 to 30 minutes of deposition time (e.g., 10 to 20 minutes, 20 to 30 minutes, or 15 to 25 mins) was optimum. However, deposition time may vary depending upon the composition of the pixel and/or the binding ligand used. Because at least part of the issue with longer deposition times appears to be the roughness of the surface of the pixel, a flattening or smoothing step may be included after the deposition process but prior to the attachment of the binding ligand. In certain instances, a roughness factor (fᵣ) of less than about 7 is desirable. As used herein, roughness factor refers to the ratio between the real surface area (Aᵣ) and the geometric surface area (A_{g}), i.e., fᵣ=Aᵣ/A_{g}. It would be understood by those in the art that an E-DNA sensor generally will have a higher tolerance, while the E-AB and E-PB sensors generally will have a lower tolerance.

In accordance with the present invention, there may be employed conventional molecular biology, microbiology, biochemical, and recombinant DNA techniques within the skill of the art. Such techniques are explained fully in the literature. The ideas disclosed herein will be further described in the following examples, which do not limit the scope of the methods and compositions of matter described in the claims.

### EXAMPLES

### Example 1

### Materials and Instrumentation

The reagents 6-mercapto-1-hexanol (C6-OH), hydrogen tetrachloroaurate hydrate (HAuCl₄.3H₂O), 8 M guanidine hydrochloride, Tris-(2-carboxyethyl) phosphine hydrochloride (TCEP), trizma base and iron-supplemented fetal calf serum were used as received (Sigma-Adrich, St. Louis, Mo.). All other chemicals were of analytical grade. All the solutions were made with deionized water purified through a Milli-Q system (18.2 MΩ·cm, Millipore, Bedford, Mass.). Physiological buffer solution (Phys, pH 7.0) consisted of 20 mM Tris, 140 mM NaCl, 5 mM KCl, 1 mM MgCl₂ and 1 mM CaCl₂.

A thiol and methylene blue (MB)-modified stem-loop oligonucleotide complementary to the K-ras gene was used as probe DNA (Biosearch Technologies, Inc., Novato, Calif.). The MB redox moiety was conjugated to the 3′ end of the oligonucleotide via succinimide ester coupling to a 3′-amino modification (MB-NHS, EMP Biotech, Berlin), thereby producing the probe sequence 5′ HS-(CH2)6-CCG TTA CGC CAC CAG CTC CAA ACG G-(CH2)7-NH-MB-3′ (SEQ ID NO:1).

The K-ras is a gene that encodes one of the proteins in the epidermal growth factor receptor (EGFR) signaling pathway. Pancreatic and lung cancers harbor high incidences of K-ras mutant alleles, and these mutations are early events in colorectal tumor development. The detection of K-ras mutations enables understanding of cancer biology and pathogenesis.

The target DNA sequence (WT-Gly) was obtained via commercial synthesis (polyacrylamide gel electrophoresis purification, Integrated DNA Technologies, Coralville, Iowa), and its sequence was as follows: WT-Gly: 5′-TTG GAG CTG GTG GCG TA-3′ (SEQ ID NO:2).

Electrochemical measurements were performed at room temperature (22±1° C.) using a CHI 1040A Electrochemical Workstation (CH Instruments, Austin, Tex.). The screen-printed carbon electrodes (SPCE) (Pine Instrument, Grove City, Pa.) were used as the substrates of the sensor, which consisted of a 2 mm diameter screen-printed carbon working electrode, a screen-printed silver-chloride reference electrode and a screen-printed counter electrode. Scanning electron microscopy (SEM) analysis was performed on a Hitachi S-4700 field-emission SEM (Hitachi High Technologies America, Inc. Schaumburg, Ill.) at an acceleration voltage of either 10 kV or 20 kV.

### Example 2

### E-DNA Sensor Preparation

SPCE were used as substrates to fabricate the E-DNA sensors. A gold film was electrodeposited on SPCE by holding the SPCE at −0.40 V vs. Ag/AgCl (3 M KCl, external refrence electrode) in a stirred gold solution (1.2 mg mL-1 HAuCl₄, 1.5 wt % HCl and 0.1 M NaCl) for various depostion time to produce a gold-plated screen-printed carbon electrode (GPE). The GPE were electrochemically cleaned by a series of oxidation and reduction cycles in 0.5 M H₂SO₄ and in 0.05 M H₂SO₄. The real area of the electrode was determined from the charge associated with the gold oxide stripping peak obtained after the cleaning process.

For the fabrication of E-DNA sensors, a mixture of 1 μL of the 200 μM probe DNA with 1 μL of 10 mM TCEP was first incubated for 1 h to reduce the disulfide bond of the probe DNA, followed by diluting the solution to 100 μL with Phys. The probe DNA was immobilized onto the surface of GPE by incubating the clean electrodes in the diluted probe DNA solution (2 μM DNA) for 1 h. The electrodes was then rinsed with water and subsequently passivated with 2 mM 6-mercapto-1-hexanol (C6-OH) for 2 h to displace nonspecifically bound oligonucleotides.

### Example 3

### Electrochemical Measurements

E-DNA sensor measurements were traditionally conducted using alternating current voltammetry (ACV) over the range −0.15 V to −0.55 V with a frequency of 10 Hz and an amplitude of 25 mV. Prior to interrogation, the electrodes were allowed to equilibrate in Phys for 30 min. The E-DNA sensor response was measured by incubating the electrodes in 1 μM of the WT-Gly target DNA (in Phys or in undiluted fetal calf serum). The sensors were interrogated at different intervals in the target solution until a stable peak current was obtained. The ratio between the stabilized peak current in the target DNA solution and the peak current in the target DNA-free solution was used to calculate the signal suppression caused by the target.

Sensor regeneration was achieved by rinsing for 30 s with deionized water for sensors utilized in Phys or by incubating with 4 M guanidine-HCl for 4 min, followed by rinsing with deionized water for 30 s, for sensors utilized in serum.

The number of electroactive DNA probes on the electrode surface, Nₜₒₜ was determined using a previously established relationship with ACV peak current described in equation 1 (O'Connor et al., 1999, J. Electroanal. Chem., 466:197; and Sumner et al., 2000, J. Phys. Chem., 104:7449):

I_{avg}(E₀)=2nfFNₜₒₜ sin h(nFE_{ac}/RT)/[cos h(nFE_{ac}/RT)+1] (Eq. 1)

Where I_{avg}(E0) is the average AC peak current in a voltammogram, n is the number of electrons transferred per redox event (n=2, MB label), F is the Faraday current, R is the universal gas constant, T is the temperature, E_{ac} is the peak amplitude, and f is the frequency of the applied ACV. Perfect transfer efficiency was assumed, and errors in this assumption would lead to underestimate probe density. Experimentally, three different frequencies were used (5, 10, 20 Hz), and the average peak current was calculated so as to give the value of Nₜₒₜ. The surface density of DNA probes was measured in the number of electroactive DNA probes per unit area.

### Example 4

### Use of an E-DNA Sensor

For these studies on the performance of an E-DNA sensor fabricated on a gold-plated screen-printed carbon electrode (GPE), an E-DNA sensor was constructed using a 25-base probe with the 15-base loop region targeting the K-ras gene. The two 5-base sequence at each termini form the double-stranded stem of the DNA probe (FIG. 2A). Alternating Current Voltammetry (ACV) measurements (Creager & Wooster, 1998, Anal. Chem., 70:4257) were performed in a customized cell with a probe DNA-modified GPE as the working electrode, a screen-printed silver-chloride reference electrode and a screen-printed carbon counter electrode (FIG. 1B). With this customized cell, only 200 μL of buffer was needed, whereas 4 mL of buffer is required when performed in a conventional electrochemical cell.

In the absence of target DNA, the sensor fabricated on a gold disk electrode gave rise to a sharp, well-defined AC voltammetric peak consistent with the ˜−0.26 V (vs. Ag/AgCl/3M KCl) formal potential of the methylene blue (MB) redox tag (FIG. 3A). For the 20-min GPE, a more negative reduction potential (˜−0.34 V) was observed, owing to the differences in the reference electrode employed (screen-printed Ag/AgCl reference electrode) (FIG. 3B). In the presence of 1.0 μM full-complement target DNA, a robust 72±1% decrease was observe in the MB reduction current with the gold disk electrode and an essentially identical response (72±1%) was observed with the 20 min-GPE. The results indicated that the sensors fabricated on prestine polycrystalline gold surfaces and the relatively rough electroplated gold surfaces perform equally well.

### Example 5

### Effect of Deposition Time

E-DNA sensors were fabricated on GPE obtained under different gold deposition time and their properties investigated (Table 1). In general, sensors constructed on 5 min-GPE were unstable, as indicated by the loss of ˜5% of the initial MB current after being incubated in the physiological buffer (Phys, pH 7.0) for 35 min. Without being bound by any theory, the short depostion time is presumed to result in incomplete plating of gold, and thus, the observed instability of the sensor is likely due to the desorption of probe DNA physisorbed onto the carbon regions of the electrode not covered with gold (FIG. 4). Since sensor stability is crucial to sensor performance, the 5 min-GPE is therefore not suitable as a subtrate for the E-DNA sensor.

Longer gold deposition time resulted in gold-plated electrodes with less exposed regions of the carbon substrate, which lead to enhanced sensor stability. The sensors fabricated on 10, 20, 30 and 40 min-GPE showed stable initial AC currents, with less than 2% signal decrease within the first 10 min of incubation and no further signal change with longer incubation time. Furthermore, the influence of gold deposition time on roughness of the electrode surface, probe density and sensor performances was investigated.

TABLE 1

| Deposition | | | | Signal |
|---|---|---|---|---|
| Time | Electrode | | Probe Density | Suppression |
| (min) | Area/cm² (a) | fᵣ (b) | Molecules · cm² (c) | (d) |
| 5 | 0.036 | 1.1 | — | — |
| 10 | 0.070 | 2.2 | (3.2 ± 0.1) × 10¹² | 69 ± 1% |
| 20 | 0.127 | 4.0 | (3.1 ± 0.2) × 10¹² | 72 ± 1% |
| 30 | 0.160 | 5.1 | (3.4 ± 0.6) × 10¹² | 69 ± 4% |
| 40 | 0.213 | 6.8 | (3.3 ± 0.8) × 10¹² | 68 ± 5% |
| Gold Disk | 0.031 | 1.0 | (4.3 ± 0.0) × 10¹² | 72 ± 1% |
| Electrode | | | | |

(a) The real surface are of GPE was estimated basing on the amount of charge consumed during the reduction of the Au surface oxide monolayer in 0.05M H₂SO₄ and a reported value of 400 μC cm⁻² was used for the calculation (Kozlowska et al., 1987, J. Electroanal. Chem., 228: 429). The electrode area is the average value for five independent sensors.
(b) The roughness factor (fᵣ) of GPE surface was defined as the ratio between the real surface area and the geometric surface area.
(c) The DNA probe density was measured in the number of electroactive DNA probes per unit gold real surface area.
(d) Hybridization times are 80 min for 10 min-GPE and 20 min-GPE and 100 min for 30 min-GPE and 40 min-GPE.

The roughness factor (fᵣ), which is defined as the ratio between the real surface area and the geometric surface area (fᵣ=Aᵣ/A_{g}), was calculated and is shown for each deposition time in Table 1. It was noted that the fᵣ of the GPEs was systematically larger than that obtained at a gold disk electrode with the same geometric area (fᵣ=1.0). In addition, the fᵣ of the GPEs increased from 2.2 to 6.8 when the gold deposition time was varied from 10 min to 40 min (FIG. 5).

FIG. 4 shows the SEM images of electrodes with 5, 10, 20, 30 and 40 min of electrodeposited gold. As observed, short electrodeposition time (i.e., <5 min) resulted in highly inhomogeneous gold nuclei on the electrode surface. Based on a previous report (Sobri et al., 2008, Surf. Interface Anal., 40:834), each nuclei grows independently at the initial stage of gold electrodeposition, which results in a large portion of the carbon electrode that is not covered with gold. Some coalescence of gold particles was observed after 10 min of deposition. After 20 min of deposition, gold particles started aggregating into larger clusters. At deposition time beyond 30 min, large three-dimensional gold architectures were observed on the electrode surface. These images confirm that the surface roughness of GPE increases with deposition time.

To understand the effect of fᵣ on E-DNA sensor performance, the surface density of electroactive DNA probes on the GPE was calculated and the values are shown in Table 1. A DNA probe concentration of 2 μM was chosen to fabricate E-DNA sensors, since the highest signal suppression is obtained with the highest probe density (Ricci et al., 2007, Langmuir, 23:6827). As indicated in Table 1, a probe density of ˜3×10¹² molecules/cm² was obtained at all of the deposition times, excluding the 5 min deposition time. The probe densities reported herein were slightly less than that obtained with the gold disk electrode (4.3×10¹² molecules/cm²), which suggests that not all the measured gold surface on the GPE, such as those areas sequestered within the large clusters, were suitable for immobilization of the DNA probes. Notably, both the 10 min-GPE and 20 min-GPE showed good reproducibility in probe density (RSD<2%, n=5) under the same experimental conditions. However, the 30 min-GPE and 40 min-GPE exhibited poorer reproducibility in the probe density (RSD>7%, n=5), despite the fᵣ being reasonably reproducible (RSD<3%, n=5). Without being bound by any particular theory, the lack of reproducibility may be due to the formation of more complex gold structures, which varies more significantly with GPEs obtained from longer gold deposition time. Thus, some electrodes possess larger areas of DNA probe-accessible gold than others, leading to irreproducibility in the probe coverage.

10 min-GPE and 20 min-GPE sensors showed excellent response to the target DNA (69±1% for 10 min-GPE and 72±1% for 20 min-GPE) under the same experimental conditions, even though the fᵣ of these gold films was about 2 and 4 times larger, respectively, than that of the gold disk electrode. This indicated that an E-DNA sensor not only operates optimally on a relatively flat gold surface, but also performs comparably well on a rougher surface. Furthermore, these sensors exhibited good reproducibility in the signal suppression (RSD<2%, n=5). The good signal suppression observed suggests that target hybridization in the E-DNA sensor was not significantly impeded by the surface roughness, in particular, when the fᵣ value is less than 4. The sensors constructed on 30 min-GPE and 40 min-GPE, however, showed poorly reproducible signal suppression (RSD>6%, n=5), presumably because some probes on the relatively rough gold surface (5<fᵣ<7) were not target-accessible. In addition, some DNA probes may be oriented such that hybridization to the target did not completely abolish the electron transfer between the redox tag and the electrode. Although the DNA monolayer on GPE was not pristine, which could have lead to dampening of the MB electron transfer rate, the sensor behavior was not significantly affected as indicated by the experimental results shown in this study.

### Example 6

### Regenerability of Sensors

While the goal was to fabricate a disposable strip-based E-DNA sensor, the regenerability of the sensor described herein was characterized and compared to a conventional E-DNA sensor. Similar to the published protocol (Xiao et al., 2007, Nat. Protoc., 2:2875), sensor regeneration was achieved by rinsing the electrode for 30 s with deionized water. While nearly 100% sensor regeneration was obtained for the gold disk electrode, poorer sensor regeneration was observed with the GPE-based sensors described herein (87%-92%), likely because of the loss of gold clusters with attached DNA probes during electrode rinsing, which is part of the sensor regeneration procedure.

Significantly and similar to sensors fabricated on gold disk electrodes, the GPE-based sensors described herein performed well, even when exposed directly to undiluted blood serum (FIG. 3C). A signal suppression of 64% was observed in 100% serum under the same experimental condition, suggesting that the selectivity of the E-DNA sensor is maintained irrespective of the electrode substrate. Moreover, for an ex-situ experiment in which the target DNA was drop-casted directly onto a DNA-modified gold film, only 10 μL of sample was required, thus allowing the sensing platform described herein to be more well-suited for clinical applications.

The E-DNA sensors described herein that were fabricated on GPEs showed attributes that were comparable to sensors constructed on gold disk electrodes. The GPE-based E-DNA sensor described herein can be used as a cost-effective DNA sensor for point-of-care medical diagnosis.

### Example 7

### Electrochemical Aptamer-Based (E-AB) Sensor

An aptamer-based electrochemical sensor was generated on a GPE using the methods discussed above. Briefly, a mixture of 2 μL of the 200 μM aptamer with 2 μL of 10 mM TCEP was first incubated for 1 hr to reduce the disulfide bond of the aptamer, followed by diluting the solution to 800 μL with a phosphate buffer (10 mM phosphate buffer, 140 mM NaCl, pH 7.4). The aptamer was immobilized onto the surface of a 20 min-GPE by incubating the electrochemically cleaned GPE in the diluted aptamer solution (0.5 μM) for 1 hr. The electrode was then rinsed with deionized water and subsequently passivated with 2 mM 6-mercapto-l-hexanol (C₆-OH) for 12+ hrs to displace the nonspecifically-bound aptamer. A schematic of the E-AB sensor is shown in FIG. 2B. In the present example, the aptamer was an anti-vascular endothelial growth factor (VEGF) aptamer having a sequence of 5′HS-C6-TTC CCG TCT TCC AGA CAA GAG TGC AGG G-C7-Methelene Blue 3′ (SEQ ID NO:3; see, for example, Potty et al., 2008, Biopolymers, 91:145-156).

FIG. 6A shows the response of the E-AB sensor to the human VEGF-165 target in 1:1 fetal calf serum:phosphate buffer. In the absence of the target protein, the sensor showed a sharp, well-defined AC voltammetric peak originating from the reduction of methylene blue (MB). In the presence of 100 nM VEGF, a significant increase (86%) in AC current was observed. The sensor was also easily regenerated as indicated by the similarity between the voltammograms obtained before sensor interrogation and after sensor regeneration.

In addition, FIG. 6B is a plot showing the reusability of an E-AB described herein. FIG. 6B shows that an E-AB sensor can be used at least 3 times without a significant loss in signal. The signal gain observed in the second and the third interrogation is slightly less than that observed in the first interrogation, probably due to the slight changes in the conformation of the immobilized aptamers with time. Notably, this behavior is also observed with E-AB sensors fabricated on gold disk electrodes, suggesting that this is not a property of the GPE, but more of a characteristic of the VEGF aptamer itself

### Example 8

### Electrochemical Protein-Based (E-PB) Sensor

An peptide-based electrochemical sensor was generated on a gold disk electrode by incubating the electrode for 5.5 hr in a solution containing 2.5 μM of thiolated peptide. The electrode was then rinsed with deionized water and subsequently passivated with 2 mM 9-mercapt-1-nonanol (C₉-OH) for 18 hrs to displace the nonspecifically-bound peptide probes. A schematic of the E-PB sensor is shown in FIG. 7. In the present example, the peptide was an epitope from the HIV-1 p24 antigen, having a sequence of HS-C11-EAAEWDRVHP -C7-Methelene Blue (SEQ ID NO:4).

FIG. 8 shows the response of the E-PB sensor to the anti-p24 antibody target in 1:1 human urine proxy:physiological buffer. In the absence of the target protein, the sensor showed a sharp, well-defined AC voltammetric peak originating from the reduction of methylene blue (MB). In the presence of 43 nM anti-p24 antibodies, however, a significant increase (˜45%) in AC current was observed after ˜1 hr of incubation (Gerasimov and Lai, 2010, Chem. Commun., 46:395-397).

It is to be understood that, while the methods and compositions of matter have been described herein in conjunction with a number of different aspects, the foregoing description of the various aspects is intended to illustrate and not limit the scope of the methods and compositions of matter. Other aspects, advantages, and modifications are within the scope of the following claims.

Disclosed are methods and compositions that can be used for, can be used in conjunction with, can be used in preparation for, or are products of the disclosed methods and compositions. These and other materials are disclosed herein, and it is understood that combinations, subsets, interactions, groups, etc. of these methods and compositions are disclosed. That is, while specific reference to each various individual and collective combinations and permutations of these compositions and methods may not be explicitly disclosed, each is specifically contemplated and described herein. For example, if a particular composition of matter or a particular method is disclosed and discussed and a number of compositions or methods are discussed, each and every combination and permutation of the compositions and the methods are specifically contemplated unless specifically indicated to the contrary. Likewise, any subset or combination of these is also specifically contemplated and disclosed.

What is claimed is:

1. An electrode comprising:
a screen-printed working electrode;
a screen-printed reference electrode;
a screen-printed counter electrode; and
gold deposited on the working electrode.

2. The electrode of claim 1, wherein the substrate is paper.

3. The electrode of claim 1, further comprising at least one binding ligand covalently attached to the gold.

4. The electrode of claim 1, wherein said binding ligand is selected from the group consisting of nucleic acids, aptamers, polypeptides, and proteins.

5. An electrochemical biosensor comprising:
a paper-substrate electrode comprising a working electrode, a reference electrode, and a counter electrode;
a gold pixel in contact with the working electrode; and
at least one binding ligand covalently attached to said gold pixel.

6. The biosensor of claim 5, wherein said binding ligand is selected from the group consisting of nucleic acids, aptamers, polypeptides, and proteins.

7. A method of making an electrochemical biosensor, comprising:
screen-printing a working electrode onto a substrate using conductive carbon inks;
screen-printing a reference electrode onto the substrate using silver/silver chloride inks;
screen-printing a counter electrode onto the substrate using conductive carbon inks;
depositing gold on the working electrode; and
covalently attaching a binding ligand to the substrate, wherein said binding ligand comprises an electron transfer moiety.

8. The method of claim 7, wherein the electrochemical biosensor is disposable.

9. The method of claim 7, wherein the substrate is paper.

10. The method of claim 7, wherein the gold is deposited by electroplating.

11. The method of claim 7, wherein the gold is gold/gold chloride.

12. The method of claim 7, wherein the depositing time for the gold is between about ten minutes to about forty minutes.

13. The method of claim 7, wherein the depositing time for the gold is about twenty minutes.

14. The method of claim 7, wherein the depositing time for the gold is about thirty minutes.

15. The method of claim 7, further comprising smoothing said gold prior to covalently attaching the binding ligand.

16. The method of claim 7, wherein the gold has a roughness factor (f) of less than about 7.

17. A method of detecting the presence of absence of a target analyte in a sample, comprising:
contacting the electrode of claim 3 with a sample;
determining whether or not a change in redox potential occurs;
wherein a change in the redox potential is indicative of the presence of the target analyte and wherein no change in the redox potential is indicative of the absence of the target analyte.

18. A method of detecting the presence of absence of a target analyte in a sample, comprising:
contacting the biosensor of claim 5 with a sample;
determining whether or not a change in redox potential occurs;
wherein a change in the redox potential is indicative of the presence of the target analyte and wherein no change in the redox potential is indicative of the absence of the target analyte.
